(19) United States
(12) Patent Application Publication
(10) Pub. No.: US 2011/0239054 A1
(43) Pub. Date: Sep. 29, 2011

(54) INFORMATION PROCESSING APPARATUS AND SIGN OF FAILURE DETERMINATION METHOD

(75) Inventor: Tooru Mamata, Akiruno-shi (JP)

(73) Assignee: KABUSHIKI KAISHA TOSHIBA, Tokyo (JP)

(21) Appl. No.: 13/155,239

(22) Filed: Jun. 7, 2011

Related U.S. Application Data
(63) Continuation of application No. 12/626,545, filed on Nov. 25, 2009.

(30) Foreign Application Priority Data
Nov. 28, 2008 (JP) 2008-305127

(51) Int. Cl. G06F 11/34

(52) U.S. Cl. 714/47.1; 714/E11.189

(57) ABSTRACT

According to one embodiment, an information processing apparatus includes a disk drive, a monitoring processing module, and a log accumulation module. The monitoring processing module configured to monitor a command which is issued to the disk drive by a disk driver program in response to a disk access request from an operating system, and a response to the command from the disk drive, and to output command identification information indicating a type of the command and response identification information indicating success or failure of processing corresponding to the command executed by the disk drive. The log accumulation module configured to accumulate the command identification information and response identification information output from the monitoring processing module as log information of the disk drive.

### CROSS-REFERENCE TO RELATED APPLICATIONS

This application is a continuation of U.S. patent application Ser. No. 12/626,545, filed Nov. 25, 2009, which is based upon and claims the benefit of priority from Japanese Patent Application No. 2008-305127, filed Nov. 28, 2008, the entire contents of both which are incorporated herein by reference.

### BACKGROUND

1. Field

One embodiment of the invention relates to an information processing apparatus having a disk drive, and a sign of failure determination method of determining the presence/absence of a sign of failure of the disk drive.

2. Description of the Related Art

In general, in an information processing apparatus such as a personal computer, a hard disk drive is used as a storage device. The hard disk drive is a disk drive for storing data in a disk storage medium called a hard disk.

A mechanism of detecting a failure of the disk drive is often provided as hardware or software for a disk drive or an information processing apparatus having a disk drive for the purpose of, e.g., protecting data stored in the disk drive.

Jpn. Pat. Appln. KOKAI Publication No. 2008-52382 discloses an failure detection method in which when execution of failure detection processing is requested, a device driver issues an input/output request to a disk drive using an failure detection processing program, and the disk drive is determined to be in a normal or abnormal state based on whether a normal response is returned in response to the input/output request.

In the failure detection method described in Jpn. Pat. Appln. KOKAI Publication No. 2008-52382, failure-detection-related disk access is executed in response to the input/output request from the dedicated failure detection processing program. If, therefore, the failure detection processing program issues a number of input/output requests to the disk drive, or if the program continues to issue an input/output request for a long period, the number of failure-detection-related disk accesses may increase, thereby degrading the system performance associated with, e.g., execution of various user programs. If an error arises in a storage area which is not accessed by an input/output request from the failure detection processing program, it is difficult for the failure detection processing program to detect an failure of the disk drive.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing the outer appearance of an information processing apparatus according to an embodiment of the present invention;

FIG. 2 is an exemplary block diagram showing the system configuration of the information processing apparatus according to the embodiment;

FIG. 3 is an exemplary block diagram showing the sequence of failure sign determination processing in the information processing apparatus according to the embodiment;

FIG. 4 is an exemplary view showing a data structure of log information stored in a log area in the information processing apparatus according to the embodiment;

FIG. 5 is an exemplary flowchart showing the processing procedure of a filter driver program when access to an HDD is requested in the information processing apparatus according to the embodiment;

FIG. 6 is an exemplary flowchart showing a procedure of log accumulation processing executed by a log utility in the information processing apparatus according to the embodiment;

FIG. 7 is an exemplary flowchart showing another procedure of the log accumulation processing executed by the log utility in the information processing apparatus according to the embodiment;

FIG. 8 is an exemplary flowchart showing a procedure of the failure sign determination processing executed by a failure sign utility in the information processing apparatus according to the embodiment; and

FIG. 9 is an exemplary flowchart showing another procedure of the failure sign determination processing executed by the failure sign utility in the information processing apparatus according to the embodiment.

### DETAILED DESCRIPTION

Various embodiments according to the invention will be described hereinafter with reference to the accompanying drawings. In general, according to one embodiment of the invention, there is provided an information processing apparatus comprising: a disk drive; a monitoring processing module configured to monitor a command which is issued to the disk drive by a disk driver program in response to a disk access request from an operating system, and a response to the command from the disk drive, and to output command identification information indicating a type of the command and response identification information indicating success or failure of processing corresponding to the command executed by the disk drive; and a log accumulation module configured to accumulate the command identification information and response identification information output from the monitoring processing module as log information of the disk drive.

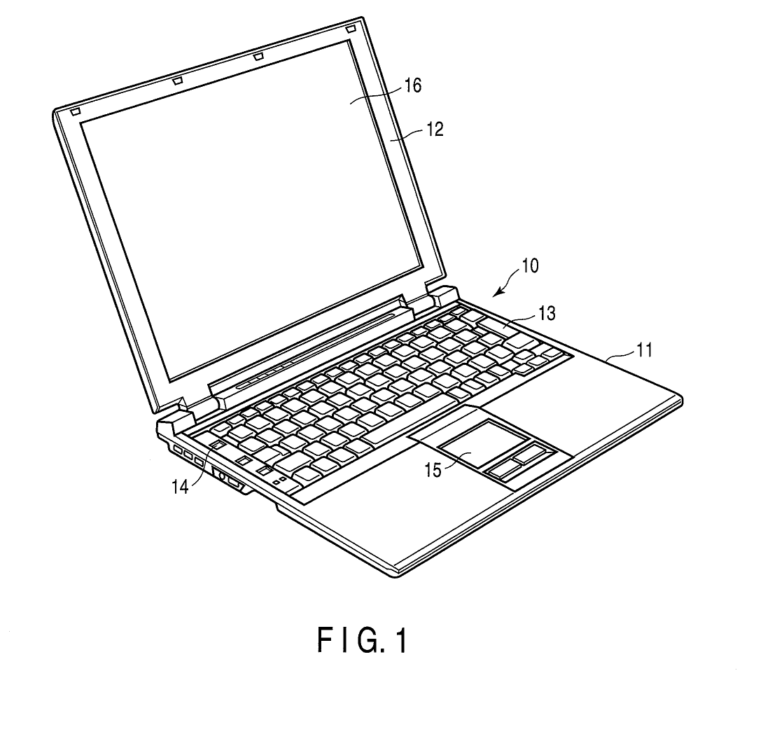

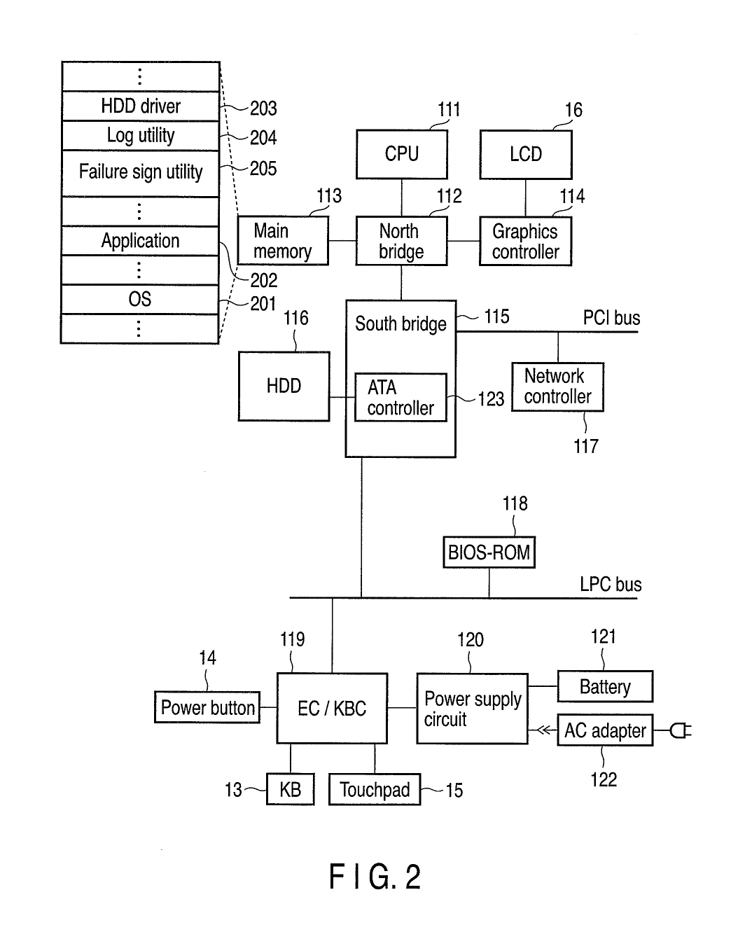

First, the arrangement of an information processing apparatus according to an embodiment of the present invention will be explained with reference to FIGS. 1 and 2. The information processing apparatus is implemented as, e.g., a portable notebook personal computer 10 which can be driven by a battery.

FIG. 1 is a perspective view showing the computer 10 in a state in which a display unit is open, when viewed from the front side.

The computer 10 includes a computer main body 11 and display unit 12. The display unit 12 incorporates a display device formed from a liquid crystal display (LCD) 16. The display screen of the LCD 16 is located almost at the center of the display unit 12.

The display unit 12 is supported by the computer main body 11, and is attached to the computer main body 11 to freely pivot between the open position where the upper surface of the computer main body 11 is exposed and the closed position where that upper surface is covered. The computer main body 11 has a thin box-shaped housing and includes, on its surface, a keyboard 13, a power button 14 to power on/off the computer 10, and a touchpad 15.

FIG. 2 shows the system configuration of the computer 10.

The computer 10 includes a CPU 111, north bridge 112, main memory 113, graphics controller 114, south bridge 115, hard disk drive (HDD) 116, network controller 117, BIOS-ROM 118, embedded controller/keyboard controller IC (EC/KBC) 119, and power supply circuit 120.

The CPU 111 is a processor which controls the operation of the components of the computer 10. The CPU 111 executes various programs which are loaded from the HDD 116 into the main memory 113. An operating system (OS) 201, application program 202, HDD driver program 203, log utility program 204, and failure sign utility program 205 are loaded into the main memory 113.

The HDD driver program 203 is a program for controlling the HDD 116 in response to access requests from the OS 201 and various programs. The HDD driver program 203 may also be called an HDD driver. The HDD driver program 203 issues a command to the HDD 116 in response to an access request, and receives a response from the HDD 116 which has executed processing corresponding to the command. A filter driver for extending the function of the HDD driver program 203 is embedded in the HDD driver program 203. The filter driver monitors the command which has been issued by the HDD driver program 203 to the HDD 116, and the response from the HDD 116 which executes processing (read/write) corresponding to the command. The filter driver then notifies the log utility program 204 of a command ID for identifying the type of command (e.g., a data read command, data write command, status read command, or status write command) issued to the HDD 116, and a response ID indicating a success or failure of the processing corresponding to the command which has been executed by the HDD 116.

When an access request is issued to the HDD 116, the log utility program 204 accumulates, as log information indicating an operation state log of the HDD 116 in a nonvolatile log area, information based on a command issued by the HDD driver program 203 and a response from the HDD 116 which has executed processing corresponding to the command. More particularly, the log utility program 204 receives a command ID and response ID from the filter driver embedded in the HDD driver program 203, and accumulates the received command ID and response ID as log information in the log area. In this case, the received command ID and response ID are not necessarily written in the log area as they are received. For example, the log utility program 204 may count, for each type of command, the number of successes and that of failures of the processing corresponding to the command executed by the HDD 116, and write log information representing the success count and failure count for each type of command in the log area, e.g., once a day. This can reduce the number of accesses to the log area, thereby preventing system performance degradation.

The log information is stored in, e.g., the HDD 116 as a nonvolatile log area, a nonvolatile memory, or an additionally provided storage device. Note that the log information may be stored in two or more of the HDD 116, nonvolatile memory, additionally provided storage device, and the like. The log information stored in the log area is used for determining the presence/absence of a sign of failure (to be referred to as an impending failure sign) of the HDD 116.

The failure sign utility program 205 reads the log information accumulated by the log utility program 204 from the nonvolatile log area, and determines the presence/absence of a sign of failure of the HDD 116 based on the read log information.

The CPU 111 also executes a basic input/output system (BIOS) stored in the flash BIOS-ROM 118. The BIOS is a program for controlling the hardware.

The north bridge 112 is a bridge device which interconnects the local bus of the CPU 111 and the south bridge 115. The north bridge 112 has a function of communicating with the graphics controller 114 via, e.g., an Accelerated Graphics Port (AGP) bus. The north bridge 112 incorporates a memory controller to control the main memory 113.

The graphics controller 114 is a display controller which controls the LCD 16 used as a display of the computer 10. The south bridge 115 is connected to a Peripheral Component Interconnect (PCI) bus and a Low Pin Count (LPC) bus.

The south bridge 115 incorporates an ATA controller 123. The ATA controller 123 controls the HDD 116 in response to a request from the HDD driver program 203.

The HDD 116 is a disk drive for storing various programs, data, and the like. An operation of, e.g., reading or writing specified data (user files, system files and the like) is executed on the HDD 116 in response to access requests from the operating system (OS) 201 and various programs. The HDD 116 is a magnetic disk drive which magnetically records data.

The embedded controller/keyboard controller IC (EC/KBC) 119 is a one-chip microcomputer on which an embedded controller for power management and a keyboard controller for controlling the keyboard (KB) 13 and touchpad 15 are integrated. The EC/KBC 119 cooperates with the power supply circuit 120 to power on/off the computer 10 in response to a user operation of the power button 14. The power supply circuit 120 uses a battery 121 incorporated in the computer main body 11 or an external power supplied via an AC adapter 122 to generate a system power to be supplied to the components of the computer 10.

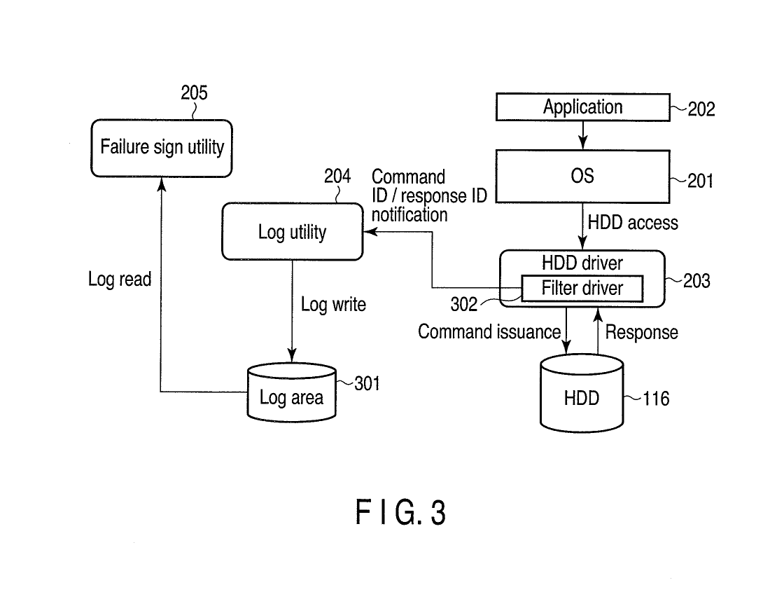

FIG. 3 is a block diagram showing a configuration of a sign of failure determination system used in this embodiment. The failure sign determination system is used for detecting any sign of a failure before the HDD 116 actually breaks down. The failure sign determination system is implemented by the log utility program 204, a log area 301, the failure sign utility program 205, and a filter driver program 302 included within the HDD driver program 203.

The filter driver is generally located between an upper system driver such as a file system driver and a physical device driver for directly controlling a device, and performs a special operation between the upper driver and the lower driver. The filter driver executes only processing corresponding to the special operation, and transmits, to the lower driver without any change, instructions and data which are not associated with the processing. That is, the filter driver can execute complicated processing including a special operation as well as an original driver operation.

The sequence of general processing when access to the HDD 116 is requested will be described below.

When the application program 202 or OS 201 requests access to the HDD 116, the OS 201 issues a disk access request (HDD access request) to the HDD driver program 203. The HDD access request is an input/output request to the HDD 116. The HDD driver program 203 issues a command to the HDD 116 in response to the HDD access request. This command is sent to the HDD 116 via the ATA controller 123. The HDD 116 executes processing corresponding to the issued command, and returns a response to the HDD driver program 203. This response is formed from a response ID indicating a success or failure of the executed processing corresponding to the command, data read from the HDD 116 by the processing, and the like.

The HDD driver program 203 sends, to the OS 201, the description of the response from the HDD 116 in response to the HDD access request sent from the application program 202 via the OS 201 or that sent from the OS 201. In the case of the HDD access request from the application program 202, the OS 201 sends the response description to the application program 202.

To determine the presence/absence of a sign of failure of the HDD 116, in addition to the above-described general processing, processing of accumulating logs associated with access to the HDD 116 and processing of determining a sign of failure based on the accumulated logs are performed in this embodiment, as will be explained below.

First, the filter driver program 302 included in the HDD driver program 203 monitors a command which is issued by the HDD driver program 203 to the HDD 116 in response to an HDD access request from the OS 201, and a response to the issued command which is output from the HDD 116 to the HDD driver program 203. That is, the filter driver program 302 extracts information necessary for determining the presence/absence of a sign of failure of the HDD 116 from the information (command and response) input/output between the HDD driver program 203 and the HDD 116. If a command newly transmitted from the HDD driver program 203 to the HDD 116 and a response to the command from the HDD 116 are detected while monitoring, the filter driver program 302 notifies the log utility program 204 of command identification information (a command ID) based on the transmitted command and response identification information (a response ID) based on the response.

The command ID is command identification information indicating the type of issued (transmitted) command. With the command ID, it is possible to identify the command issued by the HDD driver program 203 as a data read command, a data write command, a status read command, a status write command, or the like. The data read command requests to read data from the HDD 116. The data write command requests to write data in the HDD 116. The status read command and status write command request to read and write various items of status information from and in the HDD 116, respectively. The status read command and status write command are used to read and write device information such as a serial number or firmware version, respectively.

The response ID is information indicating a success or failure of the processing (data read/write processing, status read/write processing, or the like) corresponding to the issued command, which is executed by the HDD 116. Note that the response ID may be an error ID representing an error description when the processing in the HDD 116 fails.

Although the filter driver program 302 is included in the HDD driver program 203 in this embodiment, the filter driver program 302 may be inserted between the OS 201 and the HDD driver program 203. In this case, the filter driver program 302 monitors an HDD access request sent from the OS 201 to the HDD driver program 203, and a response sent from the HDD 116 to the HDD driver program 203. A command sent from the HDD driver program 203 to the HDD 116 responds to the HDD access request sent from the OS 201 to the HDD driver program 203. Monitoring the HDD access request sent from the OS 201 to the HDD driver program 203 amounts to monitoring the command sent from the HDD driver program 203 to the HDD 116.

The log utility program 204 adds date information indicating a log recording date to the command ID and response ID which have been received from the filter driver program 302, and stores the resultant data in the log area 301 as log information. The log utility program 204 writes the log information in the log area 301, e.g., once a day.

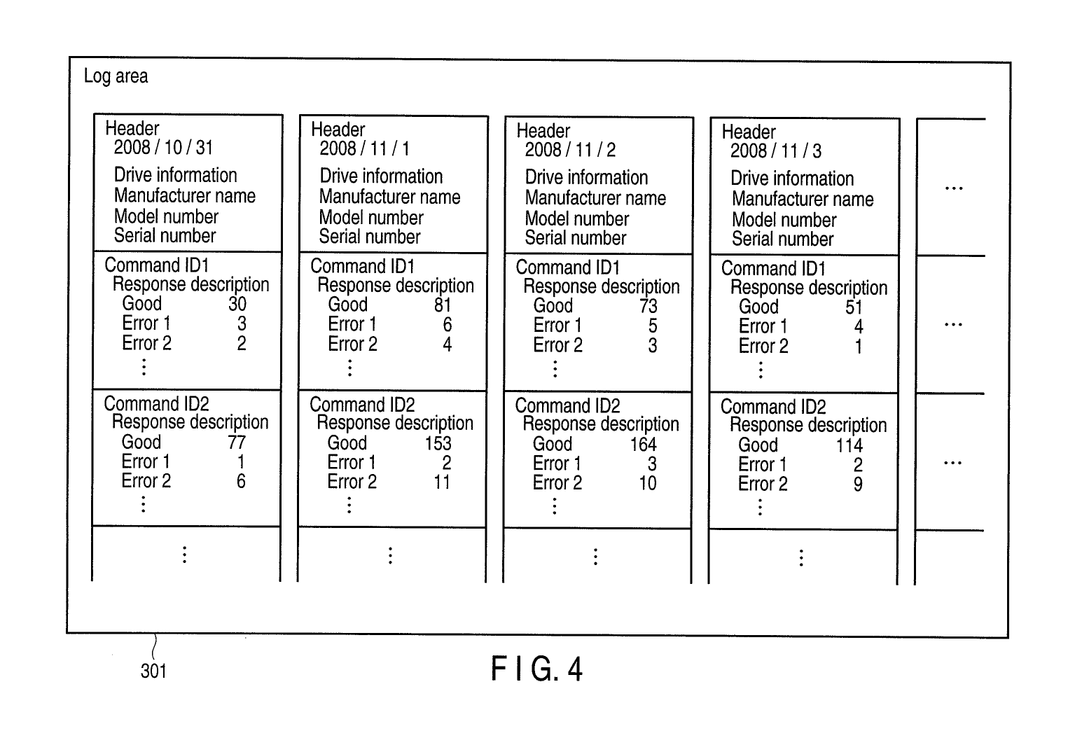

FIG. 4 shows an example of a data structure of the log information stored in the log area 301. Data as the log information stored in the log area 301 will be referred to as log data hereinafter.

As described above, the date has been added to the log data stored in the log area 301. Based on the added date, the log data is stored in the log area 301 as log data for each date which contains a header and information on a response description totalized for each type of command. The header contains the date, and information such as the drive information, manufacturer name, model number, serial number, and the like of the HDD 116. The number of successes (to be referred to as a success count hereinafter) and the number of failures (to be referred to as a failure count hereinafter) of the processing corresponding to the issued command are recorded in the response description totalized for each type of command. That is, if the response ID received by the log utility program 204 is identification information indicating that the processing in the HDD 116 has succeeded, the success count of the response description corresponding to the received command ID is incremented by one. Alternatively, if the response ID received by the log utility program 204 is identification information indicating that the processing in the HDD 116 has failed, the failure count of the response description corresponding to the received command ID is incremented by one. Note that if the response ID is an error ID representing an error description when the processing in the HDD 116 fails, the number of failures may be counted for each type of error.

Referring to FIG. 4, for example, in log data whose header contains date information “2008/10/31”, the header and information indicating the response descriptions of a command ID₁ and command ID₂ are stored in the log area 301.

The header records the date, and information on the drive information, manufacturer name, model number, and serial number of the HDD 116. The information indicating the response description of the command ID₁ records the fact that the success count (Good) is 30, the failure count due to error 1 is three, and the failure count due to error 2 is two. Similarly, the information representing the response description of the command ID₂ records the fact that success count (Good) is 77, the failure count due to error 1 is one, and the failure count due to error 2 is six.

Likewise, as for log data whose header contains date information “2008/11/1”, “2008/11/2”, or “2008/11/3”, the header and information on a response description totalized for each type of command are stored.

Based on the command ID and response ID received from the filter driver program 302, and the date, the log utility program 204 updates the log data stored in the log area 301. If, for example, the date is “2008/11/3” and the log utility program 204 receives the command ID₁ and the response ID indicating a success of processing from the filter driver program 302, in the log data example of the log area 301 shown in FIG. 4, the program 204 updates the success count (Good) recorded in the response description of the command ID₁ from 51 to 52. If the date is “2008/11/3” and the log utility program 204 receives the command ID₁ and the response ID indicating a failure of the processing due to error 1 from the filter driver program 302, in the log data example of the log area 301 shown in FIG. 4, the program 204 updates the failure count due to error 1 recorded in the response description of the command ID₁ from 4 to 5.

The log utility program 204 may count the number of successes and that of failures for one day based on the command ID and response ID received from the filter driver program 302 to end the totalization processing for the day, and may then store the totalized data as log information for the day in the log area 301. This can significantly decrease the number of accesses to the log area 301. A storage area used as the log area 301 can be provided in, e.g., the HDD 116, a nonvolatile memory, or an additionally provided storage device. A storage area used as the log area 301 may be reserved in two or more of the HDD 116, nonvolatile memory, additionally provided storage device, and the like, and log information may be recorded in a plurality of selected storage areas.

The failure sign utility program 205 reads log data from the log area 301, and determines the presence/absence of a sign of failure of the HDD 116 based on the read log data.

First, the failure sign utility program 205 totalizes the log data read from the log area 301 for each predetermined time interval, and calculates an error rate for each type of command. The error rate is calculated based on the following equation using the number of successes (success count) and the number of failures (failure count) of processing corresponding to a command in the HDD 116:

error rate X=failure count/(success count+failure count).

Note that if the number of failures is counted for each type of error in the log area 301, it is possible to use the sum of failure counts for all types of errors as the failure count in the above equation.

Next, the failure sign utility program 205 compares the error rates calculated for respective predetermined time intervals. If the error rate tends to increase with time, the program 205 determines the presence of a sign of failure of the HDD 116.

Specifically, for example, if an error rate X_new for the immediately preceding predetermined time interval is higher than an error rate X_last1 for the second preceding predetermined time interval (the predetermined time interval which immediately precedes the immediately preceding predetermined time interval) by a threshold value (e.g., 5%) of an error rate increment or more, the failure sign utility program 205 determines the presence of a sign of failure of the HDD 116. If the error rate X_new for the immediately preceding predetermined time interval is higher than the error rate X_last1 for the second preceding predetermined time interval by the threshold value of the error rate increment or more, and the error rate X_last1 for the second preceding predetermined time interval is higher than an error rate X_last2 for the third preceding predetermined time interval by the threshold value of the error rate increment or more, the failure sign utility program 205 may determine the presence of a sign of failure of the HDD 116. That is, the failure sign utility program 205 determines the presence/absence of a sign of failure of the HDD 116 based on the increasing tendency of the error rate for a plurality of time intervals.

The threshold value of the error rate increment used to determine the presence/absence of a sign of failure varies for each type of command. That is, it is possible to set the threshold value of the error rate increment based on the importance of processing by each command and the use mode of the HDD 116, as needed. If, for example, the importance of the read and write commands is higher than that of other commands, and the presence of a sign of failure is preferably determined based on a slight increase in error rate, a lower threshold value of the error rate increment is set for the read and write commands. In this way, by setting the threshold value of the error rate increment used to determine the presence/absence of a sign of failure for each type of command, it is possible to determine the presence/absence of a sign of failure with high accuracy.

The timing of executing the failure sign determination by the failure sign utility program 205 can be suitably set to, e.g., a timing when a predetermined period has elapsed since the failure sign utility program 205 was executed last time, a timing when a predetermined amount of log information is accumulated in the log area 301, or a timing when the user sends an instruction.

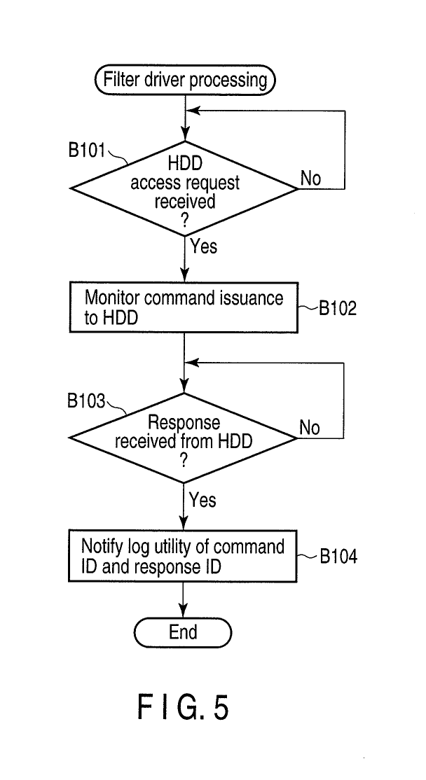

FIG. 5 is a flowchart showing a processing procedure executed by the filter driver program 302.

As described above, when the application program 202 or OS 201 requests access to the HDD 116, the OS 201 issues an HDD access request to the HDD driver program 203. The HDD driver program 203 issues a command to the HDD 116 in response to the HDD access request from the OS 201.

First, the filter driver program 302 determines whether the HDD driver program 203 has received an HDD access request from the OS 201 (block B101). If the filter driver program 302 determines that the HDD driver program 203 has received an HDD access request (YES in block B101), the filter driver program 302 monitors command issuance by the HDD driver program 203 (block B102). The HDD driver program 203 issues a command to the HDD 116 in response to the HDD access request from the OS 201. The filter driver program 302 holds the command ID of the issued command. This command is actually sent to the HDD 116 via the ATA controller 123 provided for the south bridge 115.

Next, the filter driver program 302 determines whether the HDD driver program 203 has received a response to the issued command from the HDD 116 (block B103). If the filter driver program 302 determines that the HDD driver program 203 has received a response from the HDD 116 (YES in block B103), the filter driver program 302 notifies the log utility program 204 of command identification information (a command ID) based on the issued command, and response identification information (a response ID) based on the received response (block B104). Note that the command ID is information allowing identification of the type of issued command. The response ID is information indicating a success or failure of processing corresponding to the issued command in the HDD 116. The response ID may be an error ID representing an error description when the processing in the HDD 116 fails.

Furthermore, the filter driver program 302 can notify the log utility program 204 of a response time indicating an elapsed time from when the HDD driver program 203 issues a command to the HDD 116 until the HDD 116 returns a response to the HDD driver program 203.

With this processing, the filter driver program 302 can monitor input/output between the HDD driver program 203 and the HDD 116 for a normal processing period during which the various applications are executed, extract information necessary for determining a sign of failure of the HDD 116, and notify the log utility program 204 of the information.

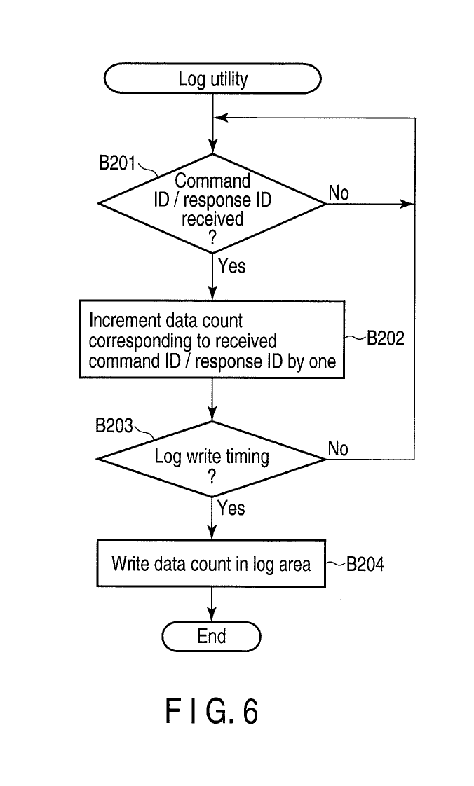

FIG. 6 is a flowchart showing a processing procedure executed by the log utility program 204. The procedure shown in FIG. 6 is a procedure when the log utility program 204 totalizes data notified from the filter driver program 302, and writes the totalized data in the log area 301.

First, the log utility program 204 determines whether it has received a command ID and response ID notified from the filter driver program 302 (block B201). If the program 204 determines to have received a command ID and response ID (YES in block B201), the log utility program 204 increments the data count corresponding to the command ID and response ID by one (block B202). That is, the log utility program 204 increments, by one, either the number of successes or that of failures of processing corresponding to the command in the HDD 116 based on the response ID for each command ID (each type of command). As described above, the response ID may be an error ID representing an error description when the processing fails. In this case, the log utility program 204 counts the number of failures for each type of error.

Such totalization processing generates log data indicating a success count and failure count for each command ID (each type of command).

The log utility program 204 then determines whether it is the timing of writing the log data in the log area 301 (block B203). In accordance with the use mode of the HDD 116, it is possible to suitably set the timing of writing the data in the log area 301 to, e.g., a timing when a predetermined period has elapsed since log data was written the last time or a timing when a predetermined amount of received data used for counting is achieved.

If it is the timing of writing the log data in the log area 301 (YES in block B203), the log utility program 204 adds the date to the header of the log data, and writes the resultant log data in the log area 301 (block B204). If it is not the timing of writing the log data in the log area 301 (NO in block B203), the log utility program 204 executes the processing in blocks B201 and B202 again.

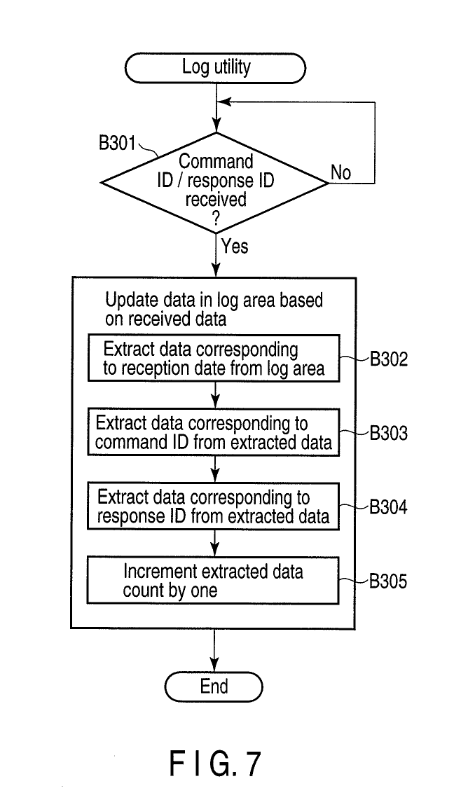

FIG. 7 is a flowchart showing another processing procedure executed by the log utility program 204. In the procedure shown in FIG. 7, the log utility program 204 updates the log area 301 every time the filter driver program 302 notifies the program 204 of data.

First, the log utility program 204 determines whether it has received a command ID and response ID notified from the filter driver program 302 (block B301). If the log utility program 204 determines to have received a command ID and response ID (YES in block B301), it updates the log area 301 based on the command ID, response ID, and date (blocks B302 to B305).

The log utility program 204 extracts log data corresponding to the current date from the log data stored in the log area 301 (block B302). The log utility program 204 then extracts log data corresponding to the received command ID from the extracted log data (block B303). The log utility program 204 further extracts log data corresponding to the received response ID from the extracted log data (block B304). The log utility program 204 increments the success count or failure count indicated by the extracted log data by one (block B305).

With this processing, the number of successes and that of failures of the processing corresponding to the command in the HDD 116 are counted for each type of command, and the log information stored in the log area 301 is updated. As described above, the response ID may be an error ID indicating an error description when the processing fails. In this case, the log utility program 204 counts the number of failures for each type of error.

When the filter driver program 302 notifies the log utility program 204 of a response time, the log utility program 204 stores information on the response time in the log area 301 for each type of command.

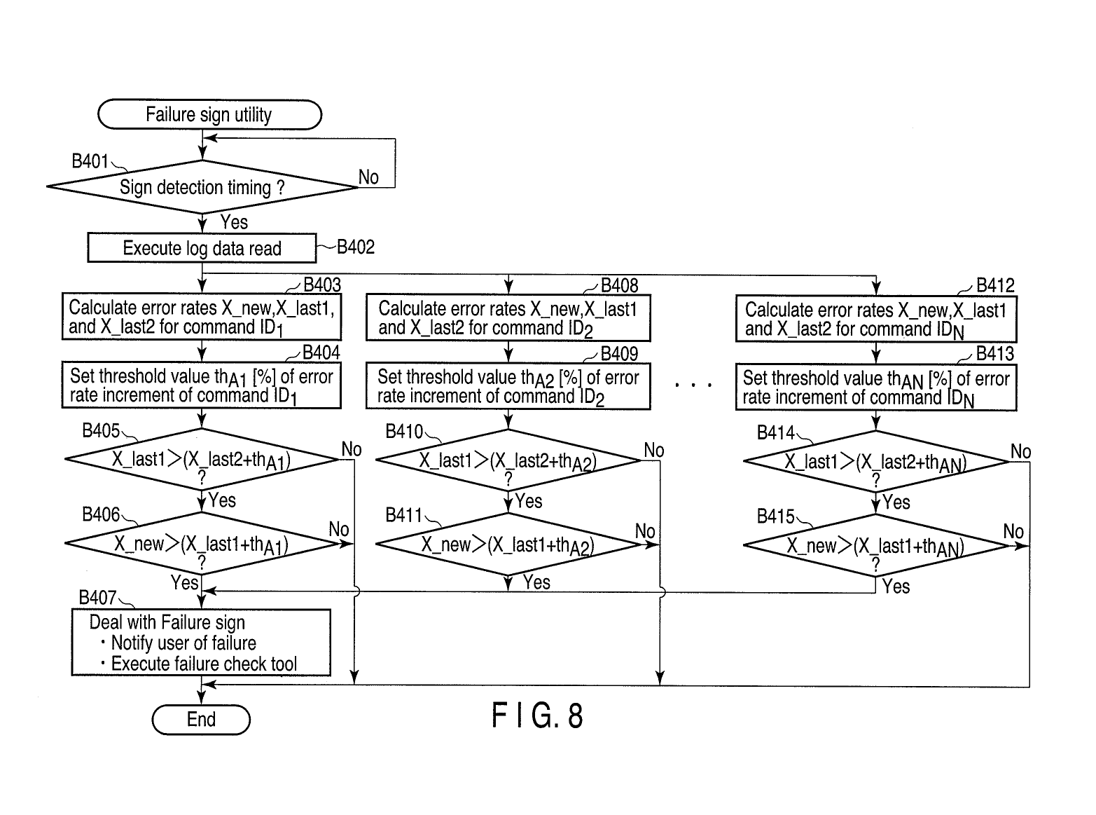

The procedure of failure sign determination processing executed by the failure sign utility program 205 will now be explained with reference to a flowchart shown in FIG. 8.

The failure sign determination processing is executed, e.g., once a week. First, the failure sign utility program 205 determines whether it is the timing of detecting the presence/absence of a sign of failure of the HDD 116 (block B401). If it is the timing of detecting the presence/absence of a sign of failure of the HDD 116 (YES in block B401), the failure sign utility program 205 reads log data necessary for determination from the log area 301 (block B402). As the log data necessary for determination, log data for the immediately preceding predetermined time interval, that for the second preceding predetermined time interval, and that for the third preceding predetermined time interval are used. More specifically, log data for last three months from the present time can be used. In this case, log data for the last month is used as the log data for the immediately preceding predetermined time interval. Log data for the second preceding month is used as the log data for the second preceding predetermined time interval. Log data for the third preceding month is used as the log data for the third preceding predetermined time interval. Based on the read log data for last three months, the failure sign utility program 205 then calculates an error rate for each interval, i.e., last month, the second preceding month, or the third preceding month. The error rate is calculated for each command ID.

That is, the failure sign utility program 205 calculates an error rate for each predetermined time interval based on the response description of the command ID₁ of the read log data (block B403). The error rate is calculated based on the following equation using the success count and failure count for each predetermined time interval which have been read from the log area 301, as described above:

error rate X=failure count/(success count+failure count).

With this equation, the failure sign utility program 205 calculates an error rate X_new for the immediately preceding predetermined time interval (last month), an error rate X_last1 for the second preceding predetermined time interval (second preceding month), and an error rate X_last2 for the third preceding predetermined time interval (third preceding month) with respect to the command ID₁.

Next, the failure sign utility program 205 sets a threshold value th_{A1} [%] of the error rate increment with respect to the command ID₁ (block B404). The failure sign utility program 205 then determines the presence/absence of a sign of failure of the HDD 116 based on the calculated error rates and the set threshold value th_{A1} [%] of the error rate increment (blocks B405 and B406).

Assume that the error rate X_last1 for the second preceding predetermined time interval is higher than the error rate X_last2 for the third preceding predetermined time interval by the threshold value th_{A1} [%] or more (YES in block B405), and the error rate X_new for the immediately preceding predetermined time interval is higher than the error rate X_last1 for the second preceding predetermined time interval by the threshold value th_{A1} [%] or more (YES in block B406). In this case, the failure sign utility program 205 determines the presence of a sign of failure of the HDD 116, and performs processing for dealing with the failure sign (block B407). For example, if

X_last1>(X_last2+th_{A1})

and

X_new>(X_last1+th_{A1}),

the failure sign utility program 205 determines the presence of a sign of failure of the HDD 116.

To deal with the case in which a sign of failure is present in the HDD 116, for example, the program 205 outputs information indicating the presence of a sign of failure of the HDD 116 to the LCD 16 or the like to notify the user of it, and prompts the user to execute a failure check tool for performing the detailed failure detection processing.

Alternatively (NO in block B405 or NO in block B406), the failure sign utility program 205 determines the absence of a sign of failure of the HDD 116, and ends the processing.

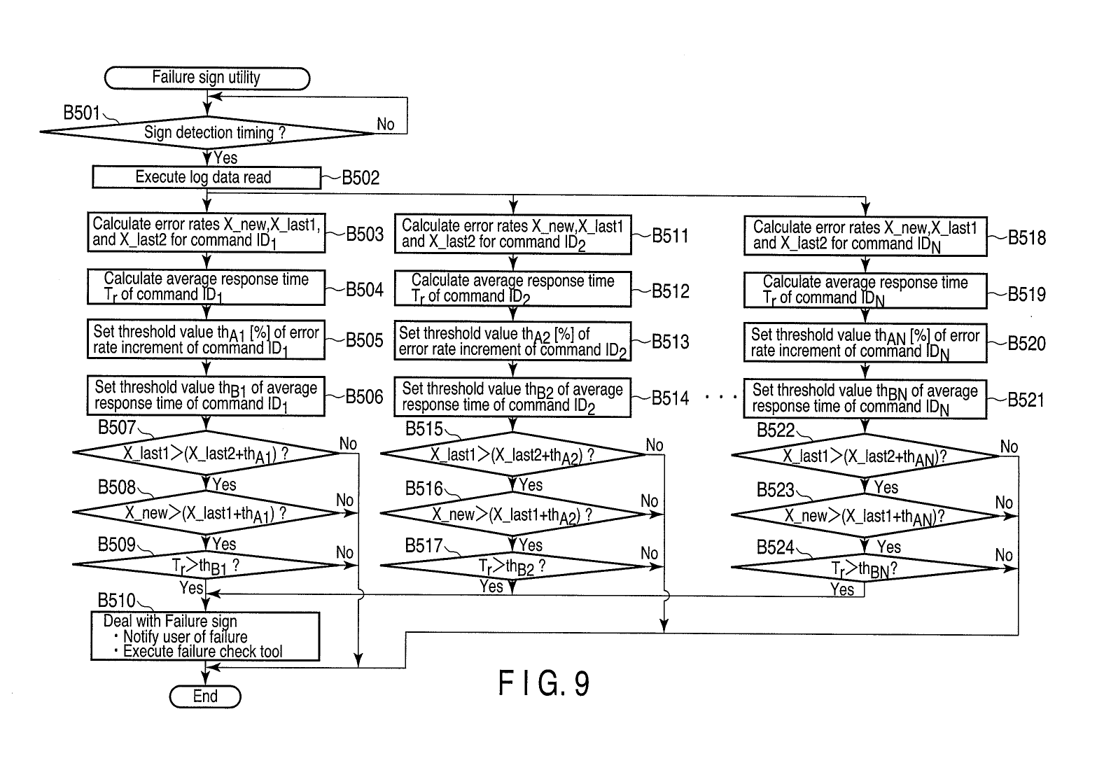

The program 205 executes, for each of commands ID₂ to ID_{N}, the same processing as the above-described processing for the command ID₁ in blocks B403 to B406 (blocks B408 to B415), and determines the presence/absence of a sign of failure for each type of command. Note that N represents the number of types of commands stored in the log area 301. If the presence of a sign of failure of the HDD 116 is determined for any type of command, the processing in block B407 is executed to deal with the failure sign, similarly to the command ID₁. The threshold value of the error rate increment varies for each command ID. That is, the failure sign utility program 205 uses a different threshold value for each command ID to determine the presence/absence of a sign of failure for the corresponding command ID. For example, a relatively small threshold value may be set for data read/write commands, and a threshold value larger than that for the data read/write commands may be set for status read/write commands. FIG. 9 is a flowchart showing another processing procedure executed by the failure sign utility program 205. In the processing based on the flowchart of FIG. 9, the failure sign utility program 205 determines the presence/absence of a sign of failure of the HDD 116 in consideration of an average response time as well as the error rates.

First, the failure sign utility program 205 determines whether it is the timing of detecting the presence/absence of a sign of failure of the HDD 116 (block B501). If it is the timing of detecting the presence/absence of a sign of failure of the HDD 116 (YES in block B501), the failure sign utility program 205 reads log data necessary for determination from the log area 301 (block B502). As the log data necessary for determination, log data for the immediately preceding predetermined time interval, that for the second preceding predetermined time interval, and that for the third preceding predetermined time interval are used.

Next, the failure sign utility program 205 calculates an error rate for each predetermined time interval based on the response description of the command ID₁ of the read log data (block B503). The error rate is calculated based on the following equation using the success count and failure count for each predetermined time interval which have been read from the log area 301, as described above:

error rate X=failure count/(success count+failure count).

With this equation, the failure sign utility program 205 calculates an error rate X_new for the immediately preceding predetermined time interval, an error rate X_last1 for the second preceding predetermined time interval, and an error rate X_last2 for the third preceding predetermined time interval.

The failure sign utility program 205 then calculates an average response time Tᵣ by averaging the response times of the command ID₁ within each predetermined time interval based on the response description of the command ID₁ (block B504).

Next, the failure sign utility program 205 sets a threshold value th_{A1} [%] of the error rate increment for the command ID₁ (block B505). The failure sign utility program 205 sets a threshold value th_{B1} of the average response time for the command ID₁ (block B506).

The failure sign utility program 205 determines the presence/absence of a sign of failure of the HDD 116 based on the calculated error rates and average response time, the set threshold value th_{A1} [%] of the error rate increment, and the set threshold value th_{B1} of the average response time (blocks B507 to B509).

Assume that the error rate X_last1 for the second receding predetermined time interval is higher than the error rate X_last2 for the third preceding predetermined time interval by the threshold value th_{A1} [%] or more (YES in block B507), the error rate X_new for the immediately preceding predetermined time interval is higher than the error rate X_last1 for the second preceding predetermined time interval by the threshold value th_{A1} [%] or more (YES in block B508), and the average response time Tᵣ is longer than the threshold th_{B1} (YES in block B509). In this case, the failure sign utility program 205 determines the presence of a sign of failure of the HDD 116, and executes processing to deal with the failure sign (block B510). For example, if

X_last1>(X_last2+th_{A1})

and

X_new>(X_last1+th_{A1})

and

Tᵣ>th_{B1},

the failure sign utility program 205 determines the presence of a sign of failure of the HDD 116.

To deal with the failure sign of the HDD 116, for example, the program 205 outputs information indicating the presence of a sign of failure of the HDD 116 to the LCD 16 or the like to notify the user of it, and prompts the user to execute a failure check tool for performing a detailed failure detection processing.

Alternatively (NO in block B507, NO in block B508, or NO in block B509), the failure sign utility program 205 determines the absence of a sign of failure of the HDD 116, and ends the processing.

The program 205 executes, for each of commands ID₂ to ID_{N}, the same processing as the above-described processing for the command ID₁ in blocks B503 to B509 (blocks B511 to B524), and determines the presence/absence of a sign of failure for each type of command. Note that N represents the number of types of commands stored in the log area 301. If the presence of a sign of failure of the HDD 116 is determined for any type of command, the processing in block B510 is executed to deal with the failure sign, similarly to the command ID₁.

The program 205 may determine the presence/absence of a sign of failure of the HDD 116 using log information for one or more specific types of commands rather than all types of commands. If, for example, log information pertaining to a data read command and write command is more important than that pertaining to a status read command and write command, the program 205 determines the presence/absence of a sign of failure of the HDD 116 only based on the log information pertaining to the data read command and write command. In this case, the failure sign utility program 205 reads only log information for necessary types of commands from the log area 301.

The procedure for determining the presence/absence of a sign of failure of the HDD 116 in consideration of the average response time for each predetermined time interval has been explained in the above-described failure sign determination processing. The program 205, however, may calculate the moving average of the response times stored as log data for each predetermined time interval, and determine the presence/absence of a sign of failure of the HDD 116 in consideration of the average response time obtained using the moving average.

As described above, it is possible to monitor access to a disk drive by a normal application program and an operating system, accumulate log data for a long period, and save a log indicating the operating status of the disk drive in this embodiment. It is also possible to determine the presence/absence of a sign of failure of the disk drive based on the accumulated log data in this embodiment. This makes it possible to perform failure sign determination in accordance with the actual user use environment by monitoring access to the disk drive by, e.g., the normal application program rather than access to the disk drive by a dedicated failure sign detection program. Since an HDD access request from the application program is sent to an HDD driver via the operating system, a filter driver program can monitor access to the disk drive by the normal application program or the operating system only by monitoring a command which is issued by the HDD driver to an HDD in response to the HDD access request from the operating system.

The filter driver program in this embodiment acquires log information by monitoring information input/output between the HDD driver and disk drive. The filter driver program, however, may acquire log information by monitoring information input/output between the operating system and HDD driver. A case in which an information processing apparatus accumulates log information pertaining to the HDD to determine the presence/absence of a sign of failure has been described in this embodiment. However, the items of log information in a plurality of information processing apparatuses may be uploaded to a server system via, e.g., a portable storage medium or network, and the server system may determine the presence/absence of a sign of failure of the HDD of each information processing apparatus.

In some cases, the HDD has a self-diagnostic function called Self-Monitoring Analysis and Reporting Technology (S.M.A.R.T.). Diagnosis information (S.M.A.R.T. information) acquired using the self-diagnosis function is stored in the HDD. The description of the S.M.A.R.T. information of the HDD is different among HDD vendors (or among models). To detect a sign of failure based on the description, it is necessary to optimize a detection method and detection level for each vendor. Since the S.M.A.R.T. information is not used in this embodiment, it is possible to determine the presence/absence of a sign of failure independently of the HDD vendor or model. That is, it is possible to absorb any specific difference between the HDD vendors or models by detecting a change in error rate or response time using the accumulated log information, and then determining the presence/absence of a sign of failure of the HDD. The presence/absence of a sign of failure of the HDD may be determined using the S.M.A.R.T. information as well as changes in error rate and response time.

The procedure of the log accumulation processing and failure sign determination processing in this embodiment can be implemented by software. It is, therefore, possible to readily obtain the same effects as in the embodiment only by installing a program for performing the procedure of the log accumulation processing and failure sign determination processing in a general computer through a computer-readable storage medium, and executing it.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a disk drive;
a monitoring processing module configured to detect a command issued to the disk drive by a disk driver program in response to a disk access request from an operating system, and a response—comprising information indicating success or a failure of processing corresponding to the command executed by the disk drive, the response being returned from the disk drive to the disk driver program, and to output command identification information indicating a type of the command and response identification information indicating the success or the failure of the processing; and
a log accumulation module configured to accumulate the command identification information and the response identification information output from the monitoring processing module as log information of the disk drive.

2. The apparatus of claim 1, wherein the log accumulation module is configured to count the number of successes and the number of failures of the processing corresponding to the command based on the response identification information for each type of the command, and to accumulate the counted number of successes and the counted number of failures as the log information.

3. The apparatus of claim 2, further comprising a failure sign determination module configured to summarize the log information for each predetermined time interval, and determine the presence/absence of a sign of failure of the disk drive based on the summarized result.

4. The apparatus of claim 3, wherein the failure sign determination module is configured to calculate an error rate by dividing the number of failures by the sum of the number of successes and the number of failures for said each predetermined time interval and to determine the presence of a sign of failure of the disk drive if a first error rate for an immediately preceding predetermined time interval is higher than a second error rate for a second preceding predetermined time interval by a first threshold value or more.

5. The apparatus of claim 3, wherein the failure sign determination module is configured to calculate an error rate by dividing the number of failures by the sum of the number of successes and the number of failures for said each predetermined time interval and to determine the presence of a sign of failure of the disk drive if a first error rate for an immediate preceding predetermined time interval is higher than a second error rate for a second preceding predetermined time interval by a first threshold value or more and the second error rate for the second preceding predetermined time interval is higher than a third error rate for a third preceding predetermined time interval by the first threshold value or more.

6. The apparatus of claim 4, wherein the failure sign determination module is configured to change the first threshold value for each item of the command identification information, and to determine the presence/absence of a sign of failure of the disk drive.

7. The apparatus of claim 1, wherein the monitoring processing module is configured to output a response time indicating an elapsed time from when the command is issued to the disk drive until the response to the command is output from the disk drive, and
the log accumulation module is configured to accumulate the response time as the log information for said each type of the command.

8. The apparatus of claim 7, further comprising a failure sign determination module configured to summarize, for each predetermined time interval, the response identification information and response times accumulated for said each type of the command as the log information, and to determine the presence/absence of a sign of failure of the disk drive based on the summarized result.

9. The apparatus of claim 5, wherein the failure sign determination module is configured to change the first threshold value for each item of the command identification information, and to determine the presence/absence of a sign of failure of the disk drive.

10. A failure sign determination method for a disk drive provided for an information processing apparatus, comprising:
detecting a command issued to the disk drive by a disk driver program in response to a disk access request from an operating system and a response comprising information indicating success or failure of processing corresponding to the command executed by the disk drive, the response being returned from the disk drive to the disk driver program, and outputting command identification information indicating a type of the command and response identification information indicating the success or the failure of the processing; and
accumulating the output command identification information and the response identification information as log information of the disk drive.

11. The method of claim 10, wherein accumulating the output command identification information and response identification information further comprises counting the number of successes and the number of failures of the processing the command based on the response identification information for each type of the command, and accumulating the counted number of successes and the counted number of failures.

12. The method of claim 11, further comprising summarizing the log information for each predetermined time interval, and determining the presence/absence of a sign of failure of the disk drive based on the summarized log information.

13. The method of claim 12, wherein determining the presence/absence of a sign of failure of the disk drive comprises calculating an error rate by dividing the number of failures by the sum of the number of successes and the number of failures for said each predetermined time interval and determining the presence of a sign of failure of the disk drive if a first error rate for an immediately preceding predetermined time interval is higher than a second error rate for a second preceding predetermined time interval by a first threshold value or more.

14. The method of claim 12, wherein determining the presence/absence of a sign of failure of the disk drive comprises calculating an error rate by dividing the number of failures by the sum of the number of successes and the number of failures for said each predetermined time interval and determining the presence of a sign of failure of the disk drive if a first error rate for an immediate preceding predetermined time interval is higher than a second error rate for a second preceding predetermined time interval by a first threshold value or more and the second error rate for the second preceding predetermined time interval is higher than a third error rate for a third preceding predetermined time interval by the first threshold value or more.

15. The method of claim 13, wherein determining the presence/absence of a sign of failure of the disk drive comprises changing the first threshold value for each item of the command identification information, and determining the presence/absence of a sign of failure of the disk drive.

16. The method of claim 10, further comprising:
outputting a response time indicating an elapsed time from when the command is issued to the disk drive until the response to the command is output from the disk drive, and
accumulating the response time for said each type of the command.

17. The method of claim 16, further comprising:
summarizing, for each predetermined time interval, the response identification information and response times accumulated for said each type of the command as the log information, and
determining the presence/absence of a sign of failure of the disk drive based on the summarized result.

18. The method of claim 14, wherein determining the presence/absence of a sign of failure comprises changing the first threshold value for each item of the command identification information, and determining the presence/absence of a sign of failure of the disk drive.
